(19) United States
(12) Patent Application Publication
(10) Pub. No.: US 2025/0112464 A1
(43) Pub. Date: Apr. 3, 2025

(54) Coordinated Feedback Mechanism and Methods

(71) Applicant: Navier, Inc., Chicago, IL (US)

(72) Inventors: Daniel Marks, Durham, NC (US); Christopher Wendell Linn, Santa Rosa, CA (US); Joshua Metnick, Chicago, IL (US); Matthew Molitor, Saint Louis, MO (US); David Steinberg, Chicago, IL (US)

(21) Appl. No.: 18/854,942

(22) PCT Filed: Apr. 2, 2023
(86) PCT No.: PCT/US23/17239

§ 371 Date: Oct. 7, 2024

Related U.S. Application Data
(60) Provisional application No. 63/327,320, filed on Apr. 4, 2022.

(51) Int. Cl. H02J 3/14; H02J 3/06

(52) U.S. Cl. CPC H02J 3/14; H02J 3/06; H02J 2310/16

(57) ABSTRACT

Machines and articles, processes for using the machines and articles, processes for making the machines and articles, and products produced by the processes of making, along with necessary intermediates, involving aspects of coordinated feedback between power producers and loads.

### I. PRIORITY STATEMENT

This application claims the benefit of U.S. Provisional Patent Application No. 63/327,320, Titled: “Coordinated Feedback Mechanism and Methods,” filed Apr. 4, 2022, and is hereby incorporated by reference in its entirety as if fully restated herein.

### II. BACKGROUND

Previous coordination involving the electrical grid and computing include, U.S. Pat. No. 11,108,237B2, titled “Building management and appliance control system’; CN106528618A, titled “Method, device and system for storing and querying data of power network monitoring system”; US20140351010A1, “System and method of democratizing power to create a meta-exchange”; U.S. Pat. No. 9,612,584B2, titled “Electric power grid control system and method for electric power control”; CN104538970B, titled “Control method for voltage and reactive power control system.”

More particularly, for example, U.S. Pat. No. 11,108,237B2 is directed to an energy storage and supply management system. The system may include one or more of a control unit, which is in communication with the power grid, and an energy storage unit that stores power for use at a later time. The system may be used with traditional utility provided power as well as locally generated solar, wind, and any other types of power generation technology. In some embodiments, the energy storage unit and the control unit are housed in the same chassis. In other embodiments, the energy storage unit and the control unit are separate. In another embodiment, the energy storage unit is integrated into the chassis of an appliance itself.

Similarly, US20140351010A1 concerns a method, a device and a system for storing and querying data of a power network monitoring system. The method comprises the following steps: firstly, transmitting data to a plurality of computers; secondly, storing the data in a memory database of any computer; transmitting the data to another computer, meanwhile receiving the data of the other computer, storing the data in a backup database, so that the computers backup the data mutually; then, transferring the data stored in the memory database of each computer into a history database, wherein the history database is set in an independent computer; and lastly, querying corresponding data from one memory database, querying the data in the backup database if the corresponding data are unavailable in the memory database or the computer in which the memory database is positioned is powered off, and querying the data from the history database if the data are not queried in the backup database. Through adoption of the method, the device and the system, the rapid query for the data acquired by the power network monitoring system is realized; the backup database can recover the data before occurrence of an accident; monitoring data are prevented from being lost; and the data integrity of a detection system is ensured.

Also note that US20140351010A1 pertains to a system and method for providing democratizing power in a power grid system. In architecture, the system includes a module for receiving a plurality of user preferences concerning load shedding using a graphical user interface, and a module for implementing the user preferences during a grid irregularity. The system is operable to aggregate power in order to facilitate continuous demand response and for emergency purposes. The method of providing democratizing power, can be broadly summarized by the following steps of determining if a device needs a transfer of energy, determining if an electric network connected to the device is able to supply backup power, and determining the quantity of the backup power. The method further includes the steps of determining the cost of the backup power and facilitating payment of the cost of the backup power.

In view of such as the foregoing, a need exists for other or better alternatives.

### III. SUMMARY

This Summary is provided to introduce the idea herein that a selection of concepts is presented in a simplified form as further described below. This Summary is not intended to identify key features or essential features of subject matter, nor this Summary intended to be used to limit the scope of claimed subject matter. Additional aspects, features, and/or advantages of examples will be indicated in part in the description which follows and, in part, will be apparent from the description, or may be learned by practice of the disclosure.

The following description and drawings are illustrative and are not to be construed as limiting. Numerous specific details are described to provide a thorough understanding of the disclosure. However, in certain instances, well-known or conventional details are not described to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

With the foregoing in mind, consider apparatuses and articles of manufacture, processes for using the apparatuses and articles, processes for making the apparatuses and articles, and products produced by the processes of making, along with necessary intermediates, in the context that some, but not all, embodiments concern coordinated feedback between power producers and consumers, or rather loads. For example, there can be a feedback apparatus directed to, or including, an electrical power grid such as a grid comprised of electrical generators and electrical interconnections. A computer system can include a bank of computers, constituting an electrical load. The computer system is configured to perform tasks and is operably connected to the electrical power grid. A controller computer, operably located intermediate the bank of computers and the electrical power grid, can facilitate feedback. For example, the controller computer can be configured to: query the electrical power grid for a state of any of the electrical generators, the electrical interconnections, and other electrical loads connected to the electrical power grid, or a portion or group thereof; and compare the state in a response to the query with at least one acceptable range. The state can be determinative of whether to take corrective action that includes any of suspending, resuming, transferring, and starting at least one of the tasks, to change the electrical load toward acceptability of the state.

### IV. INDUSTRIAL APPLICABILITY

Industrial applicability is representatively directed to that of apparatuses and devices, articles of manufacture—particularly electrical—and processes of making and using them. Industrial applicability also includes industries engaged in the foregoing, such as one or more electrical power grids, such as comprised of electrical generators and electrical interconnections, loads as connected by the interconnections to the generators, computing systems such as those involving a bank of computers, with or without a controller computer, forming a load or loads, as well as industries operating in cooperation therewith, depending on the implementation.

### V. DRAWINGS

FIG. 1 is an illustration of an embodiment.

FIG. 2 is an illustration of feedback of an embodiment.

FIG. 3 is an illustration of an embodiment that includes tasks being performed.

FIG. 4 is an illustration of an embodiment including acceptable ranges.

FIG. 5 is an illustration of an embodiment that transfers a task from a bank of computers 110.

### VI. MODES

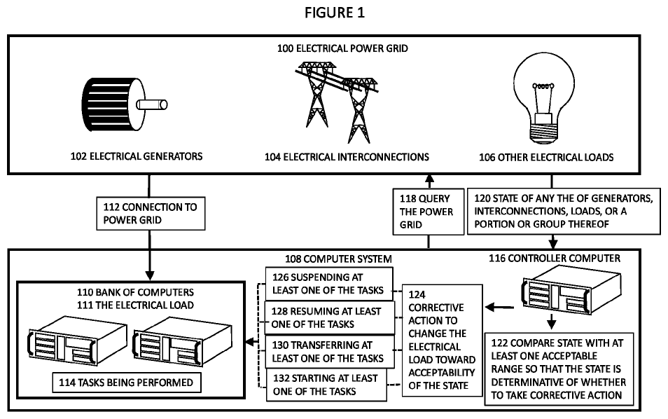

By way of a prophetic teaching, FIG. 1 is an illustration of an embodiment. An embodiment can include an electrical power grid 100. While the teaching herein refers to an electrical grid, other grids, such as ones comprising light, provide alternatives. In the present case, electrical power grid 100 comprises one or more electrical generators (and/or power generation sources) 102, electrical interconnections 104 (grid) that deliver power from the generators and/or power generation sources (though distinct, referenced herein for convenience as “generators 102”.) Receiving the electrical power are one or more other electrical loads or power consumption devices, (though distinct, referenced herein for convenience as “other loads 106”.) A bank of computers 110 with a connection to the electrical power grid 112, so as to comprise a load 111, and in some cases, a computational load. Electrical generators 102 are typically under control of an electrical power utility or an electrical grid operator, and typically involve of some combination of fossil fuel, renewable energy, and nuclear power generators, etc., but also may include other power resources such as backup generators and grid storage facilities deployed to help balance load or in the case of power failure. These sources can be instrumented so that a fraction of the generator capacity power output can be measured. Other electrical loads 106 typically include industrial, commercial, and residential equipment, for example motors and heavy machinery, furnaces, electrolysis and electrochemical cells, illumination and lighting, climate control, computers, information technology, and consumer electronics, among others. Electrical interconnections 104 typically involve three-phase high voltage transmission and distribution lines, other three-phase high voltage interconnections, other single and split-phase high voltage interconnections, various transformers that step the voltage up and down and between three phase and single-phase/split-phase, electrical switching equipment for routing power to loads as well as to protect an electrical interconnection from overload, and instrumentation to measure a fraction of the interconnection capacity that is used.

While the electrical generators 102, electrical interconnections 104, and other electrical loads 106 are disclosed as if these exist in an isolated electrical power grid 100, in practice every generator, consumer, and interconnect influences the power balance of a wider electrical power grid 100, and so a single control may cause an imbalance that ripples throughout the wider electrical power grid 100. Therefore, the effects of a single event on the electrical power grid 100, for example bringing additional electrical generators 102 online or taking other electrical loads 106 offline, should be considered throughout an extended electrical power grid 100. In an embodiment, the power consumption, such as via of the bank of computers 110, is controlled to balance the electrical generation and electrical consumption, particularly on the electrical power grid 100.

In one, but not the only, implementation, an electrical power grid 100 having electrical generators 102, electrical interconnections 104, a bank of computers 110 (with a controller computer 116 in some, but not all, embodiments) constituting a load, and other electrical loads 106. The electrical generators 102, electrical interconnections 104, and other electrical loads 106 have state 120 associated with their operation. With respect to the state, for example, electrical generators 102, state 120 may include an amount of power currently being generated by each of the electrical generators 102, total capacity of the generators 102, a status of electrical generation and other equipment describing whether or not it is functioning and parameters pertaining to its function, and whether equipment is offline for maintenance now or planned in the future, etc. For electrical interconnections 104 state 120 may include an amount of power currently being conducted by each of the interconnections 104, a direction of power flow on each interconnection 104, a status of electrical interconnection, transformation, and other equipment describing whether or not it is functioning and parameters pertaining to its function, and whether the equipment is offline for maintenance now or planned in the future, etc. For other electrical loads 106, state 120 may include an amount of power currently being consumed by each of the electrical loads, a status that can include whether or not the electrical load is functioning and parameters pertaining to its function, and whether the electrical load is offline for maintenance now or planned in the future, among other information. A bank of computers 110 is an electrical load that has state 120 that may include an amount of power currently being consumed by each computer of the bank of computers, the tasks being performed 114 by the bank of computers 110, a status indicating whether or not each computer in the bank of computers is functioning and parameters pertaining to its function, and whether a computer is offline for maintenance now or planned in the future, etc.

A goal of an electrical power utility or an electrical power grid 100 operator is to balance electrical generation and electrical consumption, that is, any difference between the two is an error to be corrected. The electrical grid is subject to unanticipated impulses or shocks such as adding additional load or equipment failure. If treated as a feedback control system, corrective action 124 can be taken in proportion to this error, or possibly in proportion to its integral or derivative, for example, to damp out the effects of these shocks and return the operation of the electrical grid to an acceptable state. In contrast, the controls available to an electrical power grid 100 operator may not have the precision to operate this way, are subject to limits so that the proportional response cannot be achieved (for example not enough electrical generation capacity is available), or have a time delay not allowing for a sufficiently rapid response. For example, an electrical interconnect 104 may be ordinarily operated within a fraction of its capacity, however, as it approaches its capacity, a rapid response may be desired to keep the electrical interconnect 104 within its capacity. Similarly, an electrical generator 102 may be operated at a reduced power output called a “spinning reserve” where its power can be increased more quickly than starting the generator from a state of producing no power, but as the generator approaches its capacity, another control with a rapid response may be desired. In extreme cases, if a corrective action 124 is not sufficiently rapid to changing electrical grid conditions, shocks can grow out of control and potentially cause widespread systems failure. If more fine-grained control could be implemented, such disasters could be avoided.

In particular, consider that even small, short-term imbalances can potentially have large effects. A similar effect is seen in other commodities markets when there is a temporary shortage or surplus causing high volatility in the price despite the fact that the change in overall inventory of the commodity may be relatively small as both supply and demand are inflexible. Computational devices that consume electrical power, such as a bank of computers 110, can have very fine-grained control of power consumption where tasks being performed 114 on the bank of computers 110 may be started 132, suspended 126, resumed 128, and transferred 130 quickly and can have the computational effort throttled with a corresponding reduction in electrical power usage. Depending on the implementation desired, one can combine a less precise and more slowly responding control, such as the generation rate of an electrical generator 102, with a computational load which has much more easily controlled power consumption, such as a bank of computers 110, the difference between the two can overall have much more fine-grained control when responding to a disturbance to the electrical power grid 100. In this way the shocks to the electrical grid can be more effectively smoothed and the electrical power grid 100 can be adjusted toward, or returned to, a state 120 of acceptability. Because renewable energy is likely to increase the volatility of the electrical power grid 100, more finely grained controls can be used to help ensure that disturbances do not become unmanageable.

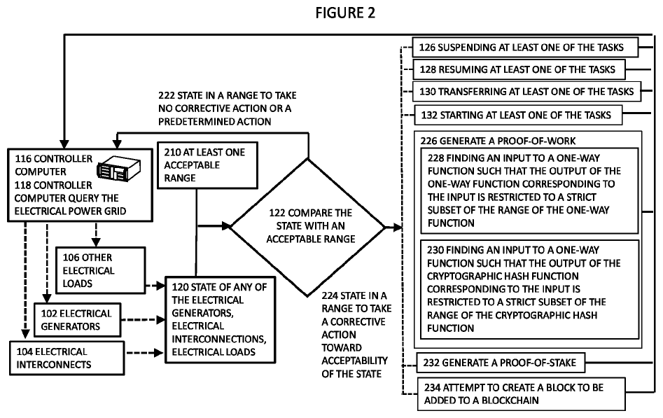

FIG. 2 is an illustration of feedback of an embodiment. An embodiment may implement a control system for feedback by including a controller computer 116 that can take a corrective action 124, 224 to return the electrical power grid 100 toward acceptability of the state 120. A controller computer may query 118 the electrical power grid 100 for the state of electrical equipment, e.g., electrical generators 102, electrical interconnections 104, other electrical loads 106 or a portion or group thereof, on the electrical power grid 100. For example, the state may include the power being generated by an electrical generator 102, the power being conducted by an electrical interconnection 104, or the power being consumed by the other electrical loads 106 on the electrical power grid, or a combination thereof. The electrical generator 102, electrical interconnection 104, or other electrical loads 106 may be instrumented to measure the information that is returned in response to a query 118. The communication between the controller computer 116 and the electrical power grid 100 including the electrical generator 102, electrical interconnection 104, or other electrical loads 106, etc., may occur over local area communications networks, wide area communications networks, wireless communications networks, power line conducted communications networks, or other communications channels, or a combination of these. The state 120 contains information communicated via one or more responses to one or more queries 118 of the electrical power grid 100. To determine the acceptability of the state 120, the state 120 can, but need not in all implementations, be compared to a goal or standard or one or more acceptable ranges 210. For example, an electrical generator 102 may have an acceptable range 210 of generated power during typical operation, or an electrical interconnection 104 may have an acceptable range 210 of conducted power, or an other electrical load 106 may have an acceptable range 210 of consumed power. The acceptability of the state 120 would be determined in part by comparing the state 122, which includes the response(s) to queries 118, and in this illustrative embodiment, by comparing the state with at least one acceptable range 122 so that the state is determinative of whether to take a corrective action 124, 224.

The controller computer 116, in this but not all implementations, can compare the state to at least one acceptable range 122. For example, the controller computer 116 may compare 122 the queried 118 electrical power in the state 120 generated by an electrical generator 102 to determine if the power is within an acceptable range 210, the controller computer 116 may compare 122 the queried 118 electrical power in the state 120 conducted by an electrical interconnection 104 to determine if the power is within an acceptable range 210, and/or controller computer 116 may compare 122 the queried 118 electrical power in the state 120 consumed by an other electrical load 106 to determine if the power is within an acceptable range 210. The controller computer 116 can compare 122 the state 120 with at least one acceptable range 210 so that the state 120 can, but need not always, be determinative of whether to take corrective action 124, 224. If the controller computer 116 determines that the state 120 is within an acceptable range 210, it may take no corrective action or a predetermined action 222. If the controller computer 116 determines that the state 120 is not within an acceptable range 210, e.g., an electrical generator 102, an electrical interconnection 104, or an other electrical load 106 has a state 120 of electrical power or other query response in the state 120 that is not within an acceptable range 210, the controller computer may take a corrective action 124, 224 toward acceptability of the state. The controller computer 116 may periodically query the electrical power grid 100 for new query 118 responses and determine whether or not the responses are within an acceptable range 210 to determine if the controller computer 116 should take no corrective action or a predetermined action 222, or take a corrective action toward acceptability of the state 124, 224. By repeating the query 118 and possibly taking corrective actions 124, 224, the controller computer 116 can implement a feedback apparatus which can maintain the state 120 of the electrical power grid 100 within an acceptable range 210. A corrective action 124, 224 may change the electrical load 111 toward acceptability of the state by suspending 126, resuming 128, transferring 130, or starting 132 at least one of the tasks 114 on the bank of computers 110. The bank of computers 110 has a connection to the electrical power grid 112 and consumes electrical energy from the electrical power grid 100. The bank of computers 110 and the controller computer 116 comprise a computer system 108, with the controller computer 116 operably located intermediate to the bank of computers 110. The power consumption of the bank of computers 110 over the connection to the electrical power grid 112 can influence electrical generators 102, electrical interconnects 104, and other electrical loads 106 on the electrical power grid 100. For example, if the electrical power consumed by the bank of computers 110 decreases, an electrical generator 102 supplying power to the bank of computers 110 may correspondingly decrease its output power. Similarly, if the electrical power consumed by the bank of computers 110 decreases, an electrical interconnection 104 supplying power to the bank of computers 110 may have a corresponding decrease in the amount of conducted power. By changing the consumed power on the bank of computers 110, the state 120 of the electrical power grid 100 may be changed toward acceptability. Because the tasks being performed 114 on the bank of computers 110 changes, the consumed power of the bank of computers 110, e.g., more tasks 114 and tasks 114 with a greater computational effort generally consuming more electrical power, the tasks 114 may be suspended 126, resumed 128, transferred 130, or started 132 on the bank of computers 110; such that control over the tasks 114 being performed affects the corresponding electrical power consumed by the bank of computers 110. A corrective action 124, 224 taken by the controller computer 116 to increase the power consumed by the bank of computers 110 could be to resume 128 or start 132 a task 114 on the bank of computers 110 which increases the number of tasks 114 being performed on the bank of computers 110. A corrective action 124, 224 taken by the controller computer 116 to decrease the power consumed by the bank of computers 110 could be to suspend 126 or transfer 130 a task 114 on the bank of computers 110 which decreases the number of tasks 114 being performed on the bank of computers 110.

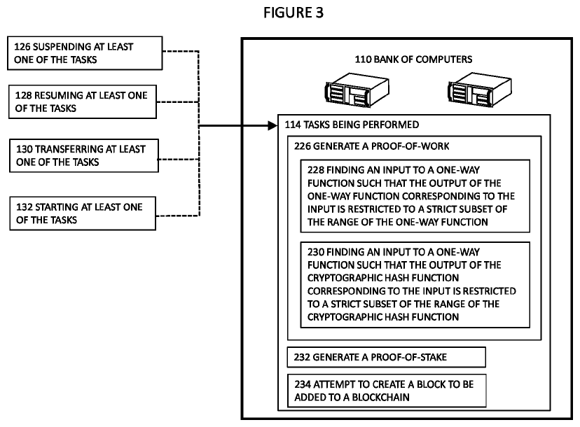

FIG. 3 is an illustration of an embodiment that provides an example of tasks being performed. In this, but not all embodiments, corrective action 124, 224 that may be taken by the controller computer 116 generates a proof-of-work 226 by resuming 128 or starting 132 a task on the bank of computers 110 that performs a proof-of-work 226. The proof-of-work 226 may be generated by steps including finding the input to a one-way function such that the output of the one-way function corresponding to the input is restricted to a strict subset of the range of the one-way function 228. The range of a function is understood to indicate the set for which the elements of that set are all of the possible values of the output of a function. A strict subset of the range of a function indicates a set that may contain only elements present in the range of the function, but must exclude at least one element of the range of the function. The proof-of-work 226 may be generated by steps including finding the input to a cryptographic hash function such that the output of the cryptographic hash function corresponding to the input is restricted to a strict subset of the range of the cryptographic hash function 230. A proof-of-work 226 may be a step in minting many types of cryptocurrency. Another corrective action 124, 224 that may be taken by the controller computer 116 generates a proof-of-stake 232, for example, by resuming 128 or starting 132 a task on the bank of computers 110 that performs a proof-of-stake. Another corrective action 124, 224 that may be taken by the controller computer 116 attempts to create a block to be added to a blockchain 234, for example, by resuming 128 or starting 132 a task on the bank of computers 110 that performs the attempt.

As an example of a corrective action 124, 224, if the generated power returned in response to a query 118 of an electrical generator 102 exceeds a limit in an acceptable range 210, the controller computer 116 could suspend 126 or transfer 130 at least one 114 task from the bank of computers 110 to lower its electrical power consumption and perhaps return the generated power of the electrical generator 102 to an acceptable range 210.

As another example of a corrective action 124, 224, if the generated power returned in response to a query 118 of an electrical generator 102 decreases below a limit in an acceptable range 210, the controller computer 116 could resume 128 or start 132 at least one 114 task from the bank of computers 110 to increase its electrical power consumption and perhaps return the generated power of the electrical generator 102 to an acceptable range 210.

As another example of a corrective action 124, 224, if the consumed power returned in response to a query 118 of an other electrical load 106 exceeds a limit in an acceptable range, the controller computer 116 could suspend 126 or transfer 130 at least one 114 task from the bank of computers 110 to lower its electrical power consumption so that the power no longer being consumed by the bank of computers 110 can be utilized by the other electrical load 106.

As another example of a corrective action 124, 224, if the consumed power returned in response to a query 118 of an other electrical load 106 decreases below a limit in an acceptable range, the controller computer 116 could resume 128 or start 132 at least one task 114 from the bank of computers 110 to increase its electrical power consumption so that the power no longer being consumed by the other electrical load 106 can be utilized by the bank of computers 110.

As another example of a corrective action 124, 224, if the conducted power returned in response to a query 118 of an electrical interconnection 104 exceeds a limit in an acceptable range 210, the controller computer 116 could suspend 126 or transfer 130 at least one 114 task from the bank of computers 110 to lower its electrical power consumption and perhaps reduce the conducted power of the electrical interconnection 104 to an acceptable range 210.

As another example of a corrective action 124, 224, if the conducted power returned in response to a query 118 of an electrical interconnection 104 decreases below a limit in an acceptable range 210, the controller computer 116 could resume 128 or start 132 at least one task 114 from the bank of computers 110 to increase its electrical power consumption and increase the conducted power of the electrical interconnection 104 to an acceptable range 210.

A task that may be useful as a task being performed 114 on the bank of computers 110 is one that does not need to be completed by a specific time, has a tolerance for being completed over a span of minutes to days over which electrical power typically becomes available to finish the tasks being processed on the bank of computers 110, and/or can tolerate the brief interruptions of being transferred between computers across the network. Cryptocurrency mining is a possible useful task, but many others, such as combinatorial optimization problems, scientific or financial computations, solving complex optimization problems such as in biophysics and bioinformatics, cloud computing, and distributed software development also are good examples. To facilitate standardizing computational resources so that more than one of the computers within a bank of computers 110 is capable of performing a given task 114, the computers within a bank of computers 110 often are constructed to have similar resources or even be identical so that a task being performed 114 on one of the computers in the bank of computers 110 may also potentially be performed by another computer in the bank of computers 110. There can be a local area network, wide area network, wireless network, or other communication network, or a combination of these interconnecting the computers in a bank of computers 110 to each other and the controller computer 116, and local area network, wide area network, wireless network, or other communication network, or a combination of these interconnecting between banks of computers 110 sited at different locations to facilitate the transferring of computation tasks between computers. A bank of computers 110 may be instrumented to measure its own power consumption.

The computers in a bank of computers 110 are characterized as having computing resources, with these resources determining what types of computation tasks each computer is capable of. For standard cloud computing resources, this includes particular microprocessors and microprocessor cores, random access memory, volatile and nonvolatile memory, file storage such as solid state and rotating media, one or more network interfaces, and general purpose graphics computing units (GPGPUs). These resources may be located on a single computer in the bank of computers 110 or be the aggregate resources of many computers in bank of computers 110. These resources may be aggregated from computers in separate 110 banks of computers. For cryptocurrency mining resources, this includes GPGPUs, field programmable gate arrays, application specific integrated circuits, or particular hash engines suited to searching for hash collisions or other specialized hardware used to mine particular cryptocurrencies.

For cloud services, a task of the tasks being performed 114 may be a virtual machine or container on one or more computers of the bank of computers 110. The corrective action 124, 224 taken by the controller computer 116 may be to suspend 126, resume 128, transfer 130, or start 132 a task that is a virtual machine or container. The network address of a task on a computer network may be abstracted by using a virtual network address such as a virtual internet protocol address (VIPA) or a mobile internet protocol so that the task may be located regardless of the actual location of the computer performing the task on the computer network. In the instance that a virtual machine task is transferred 130 to another bank of computers 110, e.g., the electrical power becomes unavailable at a bank of computers 110 currently performing the virtual machine task, accessing the virtual machine task using the virtual network address minimizes the disruption caused by the transfer 130. Similarly, by hosting other virtualized resources such as virtualized hardware devices, file servers, and database servers distributed across two or more banks of computers 110, and assigning virtual network addresses to these virtual resources, the access to these virtual resources may be made more resilient to interruptions in service.

For cryptocurrency mining services, a computer that performs cryptocurrency mining tasks (miner) of a bank of computers 110 may receive allocations of work from a cryptocurrency mining pool. The miners may either be directly in contact with a pool or in contact via a proxy service which itself receives the allocations and further distributes the allocations among the miners. A proxy service can hold the allocations in reserve for the miners so that, for example, if a miner fails to perform its work, the work allocation it was intended to perform can be handed to another miner. The proxy service may be a function performed by a controller computer 116 or a task being performed 114 on the bank of computers 110. Should a task on a miner need to be suspended 126 or the miner otherwise fails to perform the task, the proxy service can transfer 130 the allocation to another miner, either in the same computational load or in a different computational load, so that the allocated work may be completed. The proxy service virtualizes the resources of a group of miners so that the work allocations requested from a mining pool can be flexibly deployed or redeployed to a bank of miners generally at different sites and in different computer systems 108.

By performing tasks 114 that are virtual machines or containers and tasks that are work obtained by proxy on the bank of computers 110, the controller computer 116 may more flexibly respond to the state 120 of the electrical power grid 100 while providing a reliable service. These types of tasks may be transferred 130 between computers in a bank of computers 110 and to an other bank of computers 110 at an other computer system 108 more easily, e.g., where the task is easily portable using computer networks. Data may be transported much more easily and cheaply than electricity so that computing resources can act as a more fungible commodity than comparatively inflexible electrical power generation and distribution.

A controller computer 116 may take a corrective action 124, 224 based on comparing a passive control to an acceptable range 210. A passive control is a measurement on the electrical power provided over the connection to the power grid 112 that can provide information regarding the state 120 of the electrical power grid 100. Passive controls include a measurement of the voltage on the connection to the power grid 112, the oscillation frequency of alternating current on the connection to the power grid 112, and fluctuations in voltage on the connection to the power grid including temporary voltage drops or a momentary power loss. The controller computer 116 and/or the bank of computers 110 may have power conditioning circuitry or an uninterruptible power supply so that the controller computer 116 and/or bank of computers 110 can operate for a sufficient duration after power is not available on the connection to the power grid 112 to transfer its work to other computers not experiencing a loss of electrical power or other service outages, save the status of current tasks being performed 114 in a nonvolatile memory so that perhaps the tasks may be resumed at a later time, or take some other action. The controller computer 116 may, if so desired, have an uninterruptible power supply so that it can respond to the state 120 of the electrical power grid 100 even if power is not available from the electrical power grid 100 for the operation of the bank of computers 110. A passive control indicating a possible impending electrical power failure can be indicated by the connection to power grid 112 voltage or oscillation frequency falling below a threshold level, for example, below 200 Vac for a nominally 220 Vac electrical connection, or below 59.7 Hz for a 60.0 Hz nominal line oscillation frequency. A controller computer 116 can be programmed to respond to such passive controls, for example, by taking a corrective action 124, 224 to suspend 126 tasks and/or transfer 130 the tasks to an other bank of computers 110 of an other computer system 108. In this case, an acceptable range 210 of passive controls may include an acceptable range of the voltage or alternating current oscillating frequency on the connection to the power grid 112. If the controller computer 116 compares 122 the state 120 which may include passive controls to an acceptable range 210 and finds that the state 120 is within the acceptable range 210, the controller computer 116 may take a corrective action to resume 128 a task that was suspended, start 132 a task, and cause a task on an other bank of computers 110 of an other computer system 108 to be transferred back to the bank of computers 110. Passive controls can often be performed directly on the connection to the power grid 112. Furthermore, the acceptable range 210s may be such that the controller computer 116 may respond to increasing deviation of the connection to power grid 112 voltage and/or oscillation frequency from its nominal values by progressively taking corrective actions 124, 224, and so cause the bank of computers 110 to change its electrical energy consumption in proportion to the imbalance between electrical power grid 100 generation and consumption.

If reductions or outages of power can be planned in advance, for example, due to scheduled maintenance or inspections, the controller computer 116 can query 118 the electrical power grid 100 to obtain a response which indicates a possible maintenance or electrical power generation reduction event that can include the expected time of the event, the expected duration of the event, the amount of the power that is expected to remain available during the event, and an identity of electrical power grid 100 equipment that is expected to be affected including electrical generators 102, electrical interconnections 104, and other electrical loads 106 during the event, among other information regarding the event. Based on the information regarding the event incorporated into the state 120, the controller computer 116 can be programmed to take a corrective action 124, 224 that may include suspending 126, resuming 128, transferring 130, or starting 132 at least one of the tasks, for example, progressively suspending tasks and/or transferring the tasks to an other bank of computers 110 of an other computer system 108. The controller computer 116 may obtain updated information regarding the event from additional queries 118 that update the state 120, for example, a revised time at which the event is expected to end. In response to the updated state 120, the controller computer 116 may take a corrective action 124, 224 that may include suspending 126, 128 resuming, transferring 130, or starting 132 at least one of the tasks, for example, or cause a task on an other bank of computers 110 of an other computer system 108 to be transferred to the bank of computers 110.

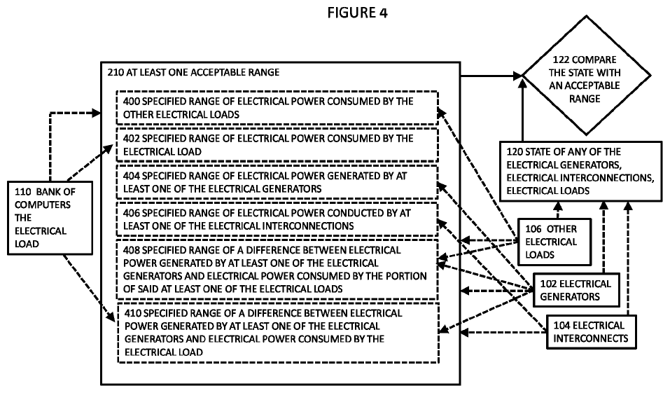

FIG. 4 is an illustration of an embodiment including acceptable ranges. The controller computer 116 may take corrective actions 124, 224 depending on the state 120 of the electrical power grid 100 as obtained from queries 118, as well as information recorded by the controller computer 116. An acceptable range 210 may be specified in various ways. For example, an acceptable range 210 can be a specified range of electrical power consumed by the other electrical loads 400, for example, the total electrical power consumed by a portion of the other electrical loads 106. An acceptable range 210 can be a specified range of electrical power consumed by the electrical load 402. An acceptable range 210 can be a specified range of electrical power generated by at least one of the electrical generators 404. An acceptable range 210 can be a specified range of electrical power conducted by at least one of the electrical interconnections 406. An acceptable range 210 can be a specified range of a difference between electrical power generated by at least one of the electrical generators and electrical power consumed by a portion of said at least one of the electrical loads 408. An acceptable range 210 can be a specified range of a difference between electrical power generated by at least one of the electrical generators and electrical power consumed by the electrical load 410.

An acceptable range 210 may be specified based on the engineered specifications or safety limits of an electrical generator 102, electrical interconnect 104, other electrical load 106, or other equipment on the electrical power grid 100 that are provided by an equipment manufacturer, an equipment servicer, engineering standards bodies, engineering consultative bodies, regulatory agencies, an electrical power utility, an electrical grid operator, etc. A safety factor may be used to reduce the acceptable range 210 from that required by safety limits in order to ensure that the electrical generator 102, electrical interconnect 104, other electrical load 106, or other equipment on the electrical power grid 100 remains within the safe operating limits of its function.

There are other possible specifications on an acceptable range 210, with these examples being illustrative.

One or more electrical power utilities, and/or one or more electrical grid operators operating a portion of the electrical power grid 100, can provide a response to a query 118 by a controller computer 116 regarding the state 120 of electrical equipment on the grid. A response can include the electrical power currently being generated and the maximum electrical power generation capacity of an electrical generator 102, the electrical power currently being conducted and the total electrical power conduction capacity of an electrical interconnection 104, and the electrical power being consumed and the total electrical power consumption capacity of an other electrical load 106. A controller computer 116 can query and receive a response from an electrical power grid through a local area network, wide area network, power line networking, a wireless connection, or a combination of these for example. The response received to the query 118 (or in some cases queries) may be recorded by the controller computer 116 as well as the corrective actions 124, 224 taken by the controller computer 116 or other controller computers 116. Furthermore, if the computers of the bank of computers 110 are instrumented to measure power consumption or passive controls, or the connection to the power grid 112 is instrumented to measure power consumption or passive controls, the controller computer 116 may record these measurements. The controller computer 116 may record the identity of tasks being performed 114, including any data pertaining to the type of a task and any information specific to the task. The controller computer 116 may make a record of electrical service faults, meteorological data, weather sensor networks, natural disasters, major events such as sports games or popular television programs that can influence the electrical power grid 100, events such as holidays, or other data relevant to predicting the state 120 of the electrical power grid 100. It could also obtain recorded data from other computer systems 108. This can provide the controller computer 116 both current and historical data regarding the state 120 of the electrical power grid 100 so that, for example, the data may be analyzed to learn how the corrective actions 124, 224 taken by the controller computer 116 or other controller computers 116 of other computer systems 108 may have affected the state 120 of the electrical power grid 100.

By analyzing a record of a controller computer 116, a range of a quantity in the record may be identified, for example, a range of the amount of generated by at least one of the electrical generators 102, a range of the amount of electrical power conducted by at least one of the electrical interconnections 104, or a range of the amount of electrical power consumed by at least one of the other electrical loads 106, or a range of combinations of sums or differences of these amounts. It may be desirable for the controller computer 116 to perform a test action that may be performed as a corrective action 124, 224 and create a record of the results of the action, and determine if a change in a range may be identified when the controller computer 116 takes the test action. It may be desirable in some cases to analyze the record to determine if a change in a range may be identified corresponding to weather events, natural disasters, sports events, popular television programs, events such as holidays, or other events that may affect the electrical power grid 100. Through this analysis, an acceptable range 210 may be determined and used to compare with the state so that the state is determinative of whether to take a corrective action 122.

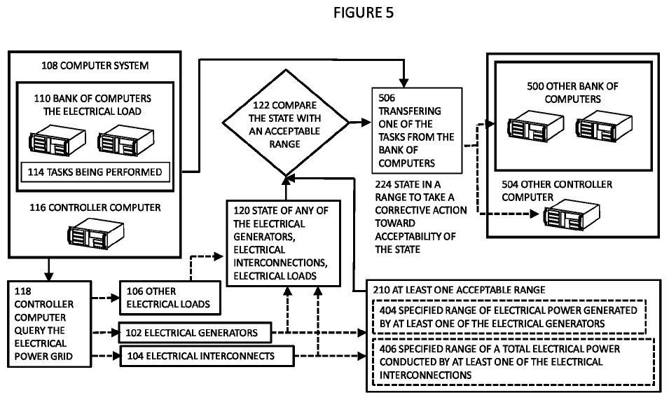

FIG. 5 is an illustration of an embodiment that transfers a task from a bank of computers 110 to an other bank of computers 500 or an other controller computer 504. In some cases, it may be desirable for a controller computer 116 to query 118 more than one electrical power grid 100, even if the electrical power grids indirectly exchange power or do not exchange power at all. Because a task being performed 114 can be made portable between a banks of computers 110 and an other bank of computers 500 through computer networks, while electrical power is transmitted through electrical power interconnections which decreases in power transmission efficiency with distance, the arbitrage of electrical power between electrical power grids that are not connected by an electrical interconnection or a sufficiently efficient electrical interconnection can occur can by exchanging tasks between banks of computers 110 that have connections to different power grids 112. A computer system 108 can include a controller computer 116 and a bank of computers 110 performing tasks 114, with the bank of computers 110 having a connection to the power grid 112. The controller computer 116 compares the state 122 with an acceptable range 210 to determine if a corrective action 124, 224 should be taken toward acceptability of the state. For example, an acceptable range may be a specified range of electrical power generated by an electrical generator 102, a specified range of electrical power conducted by an electrical interconnection 104, or a specified range of electrical power consumed by other electrical loads 106. Other examples of an acceptable range include a specified range of electrical power generated by at least one of the electrical generators 404, or a specified range of a total electrical power conducted by at least one of the electrical interconnections 406. If the controller computer 116 takes a corrective action 124, 224 toward acceptability of the state, the controller computer 116 may transfer 506 one or more of the tasks from the bank of computers to an other bank of computers 500 or an other controller computer 504. If a bank of computers 110 is connected to an electrical power grid 100, and an 500 other bank of computers is connected to an other electrical power grid 100, the transfer of a task from a bank of computers 110 to an other bank of computers 500 generally results in the bank of computers 110 to consuming less electrical power with a concomitant reduction in power draw from the connection to the power grid 112 that the bank of computers 110 is connected to, and the other bank of computers 500 consuming more electrical power with a concomitant increase in power draw from the electrical power grid that the other bank of computers is connected to. Therefore an electrical power utility or electrical grid operator operating the electrical power grid 100 can reduce the electrical power used by the bank of computers 110, making the electrical generation capacity available for other purposes, with the electrical power utility or electrical grid operator perhaps reimbursing an other electrical power utility or an other electrical grid operator operating an other electrical power grid for the extra electrical power used by a transferred task, without the two electrical power grids needing to directly exchange electrical power.

It is recognized that existing electrical power grids 100 are often composed of legacy electrical generators 102, electrical interconnections 104, and control equipment spanning decades, and the instrumentation is often widely varying and mutually incompatible. To adapt to this heterogeneity, the state 120 may be comprised of responses obtained from queries 118 of an electrical power grid 100, passive control measurements, and measurements from other instrumentation. The controller computer 116 may have to take different corrective actions 124, 224 based on the acceptable ranges 210 of responses, passive controls, and measurements included in the state 120 and combinations thereof.

In some cases, it may be desirable for the controller computer 116 to query 118 the electrical power grid 100 so that a response is received triggered on particular conditions occurring on the electrical power grid 100. For example, a controller computer 116 may query 118 the electrical power grid 100 so that a response is received by the controller computer 116 if or when the state 120 in the response to the query is within an acceptable range. Alternatively, a controller computer 116 may query 118 the electrical power grid 100 so that a response is received by the controller computer 116 if or when the state 120 in the response to the query is not within an acceptable range. The response to the query 118 would be received when the condition is satisfied, for example when the state 120 in the response to the query 118 changes as to be within an acceptable range, or alternatively when the state 120 in the response to the query 118 changes as to be not within an acceptable range. The communication of the response to the query 118 is triggered by the satisfaction of the condition. By triggering the communication of the response on a condition, the controller computer 116 may not need to query 118 the electrical power grid 100 to determine if at a particular time the condition is satisfied, e.g., the response to the query 118 is communicated to the controller computer 116 at the time the condition is satisfied. The controller computer 116 can take a corrective action 124, 224 based on the response to the query 118 that is communicated at the time the condition is satisfied, as it may respond to any other query 118.

In some cases, it may be desirable for the controller computer 116 to query 118 the electrical power grid 100 to determine if electrical equipment, for example, an electrical generator 102, electrical interconnect 104, or other electrical loads 106, responds to the query 118. If an item of electrical equipment does not respond to a query, for example, the controller computer 116 may conclude that there is a possible impending or current failure and take a corrective action 124, 224, for example to suspend 126, resume 128, transfer 130, or start 132 at least one of the tasks. The controller computer 116 may send a query 118 to an item of electrical equipment periodically, for example, once every five seconds. The controller computer 116 query 118 may request that the response include salient information regarding the electrical equipment including electrical power being generated, the types of electrical generator 102 being used to produce the power and the amount of electrical power being generated by each type of electrical generator 102, and the status of any subsystems of the electrical equipment, and any other status information regarding the electrical power grid 100. The query 118 may request that the response contain, e.g., information, or only information, that has changed since the last query by the controller computer 116 to the electrical power grid 100. The electrical equipment of the electrical power grid 100 may respond to each query 118. The state 120 may include an interval of time elapsed since the controller computer 116 last received a response to a query to an item of 116 electrical equipment. The controller computer 116 may compare 122 to an acceptable range 210 the interval of time elapsed since the controller computer 116 last received a response to a query 116 to the electrical equipment, and take a corrective action 124, 224. For example, a corrective action 124, 224 may be taken by the controller computer 116 if an interval of 30 seconds or more has elapsed since the controller computer 116 last received a response to a query 116 from the electrical equipment.

In other cases, it may be desirable for a controller computer 116 to estimate the power consumed by a bank of computers 110 or an other bank of computers 500 rather than query the bank of computers 110, an other bank of computers 500, or the electrical power grid 100 for the power consumed by the computers. A group of computers comprising a bank of computers 110, or an other bank of computers 500, may not have sufficient instrumentation to measure the power consumed by its computers, or may need to estimate the power consumed by a subset of the computers, where the subset of the computers may not be instrumented to measure its power separately from the other computers. As the power consumed by a computer generally increases as the computer performs more tasks, the controller computer 116 may query a bank of computers 110 or an other bank of computers 500 or an other controller computer 504 for the current tasks being performed on each of the computers of the load, or the controller computer 116 may maintain a record of the tasks being performed on each of the computers of the load. Using data collected regarding the typical power consumption of each computer and the power consumption of the tasks being performed on each computer, the controller computer 116 may estimate the power consumption of a group of computers that comprise a subset or a complete set of the computers that comprise a bank of computers 110 or an other bank of computers 500. The controller computer 116 can then use this estimate of the electrical power consumption based on the tasks being performed 114 by the computers to compare to an acceptable range 210 to determine whether to take a corrective action 124, 224.

How a computer system 108 is utilized also depends on its location within the larger electrical power grid 100. Strategies to place computer systems 108 at sites on the electrical power grid 100 where the computer system 108 can have different roles in balancing electrical generation and electrical consumption include: demand sited, generation sited, and connection or substation sited.

A demand sited computer system 108 is sited so that the computer system 108 can compensate for additional electrical consumption demand at a particular location on the electrical power grid 100. A demand sited computer system 108 is typically incorporated into a part of the grid where there are already many other electrical loads 106, for example, an urban area. The computer system 108 may be operated to maintain the total electrical power consumption of the bank of computers 110 and one or more other electrical load 106s within an acceptable range 210. A controller computer 116, having compared the state 120 of the total electrical power consumption of other electrical loads 106 to an acceptable range 210, may take a corrective action 124, 224 so that the total electrical power consumption of the bank of computers 110 and the other electrical loads 106 remains within an acceptable range 210. In this way, the controller computer 116 may prevent the electrical loads at the demand sited location in the electrical power grid 100 from exceeding the electrical power generation or electrical power transmission capacity available. A demand sited computer system 108 may use infrastructure already present on the electrical power grid 100, and in view of the revenue to the electrical power utility from the electrical power consumption of the bank of computers 110, the electrical power utility can more easily amortize the costs of adding additional infrastructure.

A generation sited computer system 108 is sited near at least one electrical generator 102, for example, electrical generation sources that produce slowly changing amounts of power such as nuclear generators, and variable amounts of power such as renewable energy source such as photovoltaic panels, hydroelectric generation, and wind turbine generators. A generation sited computer system 108 may be able to obtain electrical power cheaply in view of the proximate electrical generator has unused electrical generation capacity. The computer system 108 may be operated to maintain the difference between the electrical power output by one or more electrical generators 102 and the electrical power consumed by the bank of computers 110 within an acceptable range 210. A controller computer 116, having compared the state 120 of the total electrical power generated by one or more electrical generators 102 to an acceptable range 210, may take a corrective action 124, 224 so that the difference between the total electrical power generated by the one or more electrical generators 102 and the electrical power consumed by the bank of computers 110 is within an acceptable range 210. In this way, the control computer 116 may help the electrical generators 102 maintain a reserve amount of power available for other electrical loads 106.

A connection or substation sited computer system 108 is sited near an electrical interconnection 104 or an electrical substation, such as electrical interconnects 104 that exceed 100 kV and connect major metropolitan areas and distant cities. If an electrical power utility or an electrical generator 102 primarily serves one metropolitan area, and it is connected via an electrical interconnect 104 to a second metropolitan area primarily served by another an other electrical power utility or an other electrical generator 102, the two electrical power utilities or electrical generators under normal circumstances may not need to exchange significant power over the electrical interconnection 104 between them if both are properly provisioned as to be able to supply the electrical power to their respective domains. Therefore, under normal circumstances the electrical interconnection 104 may be available to conduct electrical power to be used by a bank of computers 110 to perform tasks 114, and the bank of computers 110 can draw on unused electrical generation capacity from either electrical power utility or either electrical generator 102. The computer system 108 may also serve to regulate the balance of electrical power generation and electrical power consumption on portions of the electrical power grid 100 connected together by the electrical interconnection 104, as being connected to the electrical interconnection 104, an electrical power utility or electrical grid operator needing the power could divert power from the bank of computers 110 drawing power from the electrical interconnection 104 to where the electrical power is temporarily needed. Also, if the bank of computers 110 consumes less electrical power, the electrical power conducted by the electrical interconnection 104 may be reduced which may aid to keep the electrical interconnection 104 or electrical substation within its electrical power conduction capacity. The controller computer 116 may query 118 the electrical power grid 100 at both ends of the electrical interconnection 104 so that electrical generation and electrical consumption may be balanced between the systems on both ends of the electrical interconnection.

How a particular computer system 108 is sited can, but need not always, depend on such factors as how important it is for electrical generation and electrical consumption is balanced at the site, and whether or not the computer system 108 operator or the electrical power utility or electrical grid operator can benefit sufficiently by buying or selling surplus power to make the site profitable. The reliability of the electrical power grid 100 is that it has a tangible economic value that is priced by the lost revenues, damaged equipment, additional labor costs, economic and bodily harm to energy subscribers, as well as the loss of public goodwill. Therefore, it is likely that the economic benefit of stabilizing the electrical power grid 100 is greater than the additional revenue in view of the sale of excess electrical generation capacity.

In sum, it is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Variation from amounts specified in this teaching can be “about” or “substantially,” so as to accommodate tolerance for such as acceptable manufacturing tolerances.

The foregoing description of illustrated embodiments, including what is described in the Abstract and the Modes, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

1. A feedback apparatus comprising:
an electrical power grid comprised of electrical generators and electrical interconnections; and
a computer system comprising:
a bank of computers, constituting an electrical load, that perform tasks operably connected to the electrical power grid, and
a controller computer, operably located intermediate the bank of computers and the electrical power grid, the controller computer configured to:
query the electrical power grid for a state of any of the electrical generators, the electrical interconnections, and other electrical loads connected to the electrical power grid, or a portion or group thereof; and
compare the state in a response to the query with at least one acceptable range so that the state is determinative of whether to take corrective action, the corrective action comprising any of suspending, resuming, transferring, and starting at least one of the tasks, to change the electrical load toward acceptability of the state.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A method of using a feedback apparatus, the method comprising:
operating a controller computer communicating with a bank of computers and an electrical power grid, the electrical power grid comprised of electrical generators and electrical interconnections, and the bank of computers operably connected to the electrical power grid, constituting an electrical load, and performing tasks;
the operating including:
querying the electrical power grid for a state of any of the electrical generators, the electrical interconnections, and other electrical loads connected to the electrical power grid, or a portion or group thereof; and
comparing the state in a response to the query with at least one acceptable range so that the state is determinative of whether
to take corrective action, and wherein the taking the corrective action comprises any of suspending, resuming, transferring, and starting at least one of the tasks, so as to change the electrical load toward acceptability of the state.

44. The method of claim 43, wherein the taking the corrective action includes generating a proof-of-work.

45. The method of claim 43, wherein the taking the corrective action includes generating a proof-of-stake.

46. The method of claim 43, wherein the taking the corrective action includes attempting to create a block to be added to a blockchain.

47. The method of claim 43, wherein the bank of computers performs the tasks so as to attempt to create a block to be added to a blockchain.

48. The method of claim 44, wherein the proof-of-work is generated by steps including finding an input to a cryptographic hash function such that output of the cryptographic hash function corresponding to the input is restricted to a strict subset of a range of the cryptographic hash function.

49. The method of claim 43, wherein the bank of computers performs the tasks so as to generate a proof-of-work.

50. The method of claim 43, wherein the bank of computers performs the tasks so as to generate a proof-of-stake.

51. The method of claim 44, wherein the bank of computers performs the tasks by finding an input to a cryptographic hash function such that output of the cryptographic hash function corresponding to the input is restricted to a strict subset of a range of the cryptographic hash function.

52. The method of claim 49, wherein the proof-of-work is generated by finding an input of a one-way function such that output of the one-way function corresponding to the input is restricted to a strict subset of a range of the one-way function.

53. The method of claim 49, wherein the proof-of-work is generated by finding an input of a cryptographic hash function such that output of the cryptographic hash function corresponding to the input is restricted to a strict subset of a range of the cryptographic hash function.

54. The method of claim 43, wherein the taking the corrective action to change the electrical load toward acceptability of the state includes a change toward acceptability of electrical power consumed by the other electrical loads.

55. The method of claim 43, wherein the taking the corrective action to change the electrical load toward acceptability of the state includes a change toward acceptability of electrical power consumed by the electrical load.

56. The method of claim 43, wherein the taking the corrective action to change the electrical load toward acceptability of the state includes a change toward acceptability of the state of the electrical power generated by at least one of the electrical generators.

57. The method of claim 43, wherein the taking the corrective action to change the electrical load toward acceptability of the state includes a change toward acceptability of the state of the electrical power conducted by at least one of the electrical interconnections.

58. The method of claim 43, wherein the taking the corrective action to change the electrical load toward acceptability of the state includes a change toward acceptability of a difference between electrical power generated by at least one of the electrical generators and electrical power consumed by the portion of said at least one of the electrical loads.

59. The method of claim 43, wherein the taking the corrective action to change the electrical load toward acceptability of the state includes a change toward acceptability of a difference between electrical power generated by at least one of the electrical generators and electrical power consumed by the electrical load.

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. The method of claim 43, wherein the taking the corrective action is carried out with at least one of the tasks being a cryptocurrency mining task.

78. (canceled)

79. (canceled)

80. (canceled)

81. (canceled)

82. (canceled)

83. (canceled)

84. (canceled)

85. A method of making a feedback apparatus, the method comprising:
configuring a controller computer to communicate with a bank of computers and an electrical power grid, the electrical power grid comprised of electrical generators and electrical interconnections, the bank of computers operably connected to the electrical power grid, constituting an electrical load, and performing tasks, such that the controller computer carries out the operations of:
querying the electrical power grid for a state of any of the electrical generators, the electrical interconnections, and other electrical loads connected to the electrical power grid, or a portion or group thereof; and
comparing the state in a response to the query with at least one acceptable range so that the state is determinative of whether to take corrective action, and wherein
the taking the corrective action comprises any of suspending, resuming, transferring, and starting at least one of the tasks, so as to change the electrical load toward acceptability of the state.

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. (canceled)

115. (canceled)

116. (canceled)

117. (canceled)

118. (canceled)

119. (canceled)

120. (canceled)

121. (canceled)

122. (canceled)

123. (canceled)

124. (canceled)

125. (canceled)

126. (canceled)
